(19) United States
(12) Patent Application Publication
(10) Pub. No.: US 2025/0332983 A1
(43) Pub. Date: Oct. 30, 2025

(54) METHODS AND APPARATUS TO DETERMINE A CURRENT LOAD PITCH ANGLE OF A VEHICLE FOR AUTOMATIC HEADLAMP RANGE ADJUSTMENT

(71) Applicant: Ford Global Technologies, LLC, Dearborn, MI (US)

(72) Inventors: Matthias Christian Reiter, Aachen (DE); Lars Michael Lottner, Odenthal (DE)

(21) Appl. No.: 19/188,856

(22) Filed: Apr. 24, 2025

(30) Foreign Application Priority Data
Apr. 29, 2024 (DE) 102024111960.8

(51) Int. Cl. B60Q 1/10

(52) U.S. Cl. CPC B60Q 1/10

(57) ABSTRACT

The disclosure relates in general to an automatic headlamp range adjustment system and to methods and apparatus to determine a current load pitch angle of a vehicle with an automatic headlamp range adjustment system. An example method to adjust a headlamp of a vehicle includes capturing data from a sensor during a first time interval, based on the data, determining whether a load of the vehicle has changed, if the load of the vehicle has not changed during the first time interval, determining an averaged pitch angle of the vehicle, wherein determining the averaged pitch angle includes averaging the data captured during the first time interval, determining a load pitch angle based on the determined pitch angle, and adjusting a position of the headlamp of the vehicle based on the load pitch angle.

### RELATED APPLICATION

This patent claims priority from DE Patent Application Number 102024111960.8 which was filed on Apr. 29, 2024, and is hereby incorporated herein by reference in its entirety.

### FIELD OF THE DISCLOSURE

The disclosure relates in general to an automatic headlamp range adjustment system and to methods and apparatus to determine a current load pitch angle of a vehicle with an automatic headlamp range adjustment system.

### BACKGROUND

A pitch angle of a vehicle can be determined using two mechanical height sensors, wherein a first height sensor is mounted on the front axle and a second height sensor is mounted on the rear axle. The height sensors provide information about a change in the suspension height, in which case an electrical output signal from the height sensor changes to influence a headlamp angle of the vehicle.

### SUMMARY

An example method to adjust a headlamp of a vehicle includes capturing data from a sensor during a first time interval, based on the data, determining whether a load of the vehicle has changed, if the load of the vehicle has not changed during the first time interval, determining an averaged pitch angle of the vehicle, wherein determining the averaged pitch angle includes averaging the data captured during the first time interval, determining a load pitch angle based on the determined pitch angle, and adjusting a position of the headlamp of the vehicle based on the load pitch angle.

An example method to adjust a headlamp range of a headlamp of a vehicle includes determining a setting position of the headlamp, determining a current load pitch angle of the vehicle, determining a load of the vehicle, after a load of the vehicle has changed during a first time interval, determining a deviation of the current load pitch angle of the vehicle from the setting position, and adjusting a position of the headlamp.

An example apparatus to adjust a headlamp range of a headlamp of a vehicle includes a first device to determine an averaged pitch angle of the vehicle, a second device to capture a parameter indicating a change in the load of the vehicle, and a control device including machine-readable instructions to cause the control device to receive first data from the first device, the first date including the averaged pitch angle of the vehicle, receive second data from the second device, the second data including the parameter characterizing the change in the load of the vehicle, determine whether the load of the vehicle has changed during a first time interval based on the second data, and after the load of the vehicle has not changed during the first time interval, determine a load pitch angle based on the first data and the second data.

### BRIEF DESCRIPTION OF DRAWINGS

FIG. 1 is a flowchart representative of example machine-readable instructions and/or example operations that may be executed, instantiated, and/or performed by example programmable circuitry to implement example methods disclosed herein for determining a current load pitch angle of a vehicle including an automatic headlamp range adjustment system.

FIG. 2 shows an example diagram including deviations of measured values that occur in a camera-based determination of the pitch angle because of a change in load.

FIG. 3 is a flowchart representative of example machine-readable instructions and/or example operations that may be executed, instantiated, and/or performed by example programmable circuitry to implement example methods disclosed herein for determining a current load pitch angle of a vehicle including an automatic headlamp range adjustment system.

FIG. 4 is a flowchart representative of machine-readable instructions and/or example operations that may be executed, instantiated, and/or performed by example programmable circuitry to implement example methods disclosed herein for automatic headlamp range adjustment.

FIG. 5 shows an example vehicle including an apparatus to perform headlamp range adjustment in accordance with the teachings of this disclosure.

FIG. 6 is a block diagram of an example processing platform including programmable circuitry structured to execute, instantiate, and/or perform the example machine readable instructions and/or perform the example operations of FIGS. 1, 3, and 4.

In general, the same reference numbers will be used throughout the drawing(s) and accompanying written description to refer to the same or like parts. The figures are not necessarily to scale.

### DETAILED DESCRIPTION

Examples disclosed herein relate to methods for determining the current load pitch angle of a vehicle for automatic headlamp range adjustment of at least one headlamp of the vehicle. Examples disclosed herein relate to methods and apparatus to adjust the headlamp range of at least one headlamp and may be implemented in at least one of a vehicle, a computer-implemented method, a computer program product, or a computer-readable medium including instructions to be executed by a processor.

In examples disclosed herein, pitch angle is understood as meaning the current angle of the vehicle above the ground. Pitch angle is generally rapidly variable and is influenced not only by the load of the vehicle, the vehicle longitudinal dynamics, in particular braking, acceleration, as well as going uphill and downhill due to additional power requirements, but also by random road bumps. In examples disclosed herein, the factory condition or calibration condition or the condition of an unladen vehicle is defined as a condition with a pitch angle of zero degrees. All other angles describe a deviation from the factory condition or from the unladen condition.

In examples disclosed herein, an averaged pitch angle is understood as meaning the measurement angle of a system that determines an averaged pitch angle during operation of the vehicle (e.g., a camera that determines a horizon angle via a series of images). In examples disclosed herein, load pitch angle is understood as meaning the quasi-static portion of the pitch angle that depends on the load and not on the driving conditions. It corresponds to the angle that is set when at a standstill in a plane. The dynamic pitch angle is understood as meaning the current (e.g., instantaneous), rapidly variable deviation from the load pitch angle (e.g., the portion of the pitch angle which depends on, for example, the driving situation (braking, accelerating, going uphill, going downhill, etc.).

To determine the dynamic pitch angle, the longitudinal acceleration of the vehicle can be measured, which usually correlates with the dynamic pitch angle, because the dynamic pitch angle is mainly caused by acceleration forces that act on a predominantly linearly sprung system.

Automatic headlamp range adjustment systems require the current load pitch angle of the vehicle in relation to the road as an input variable. A change in the pitch angle can occur because of the driving conditions or because of loading or unloading of the vehicle such as, for example, an automobile with a loaded trunk. When the load pitch angle changes, the headlamps can be readjusted (e.g., corrected upward or downward with respect to their beam angle) to avoid dazzling (e.g., blinding, high-beaming, etc.) the oncoming traffic, for example, as a result of headlamps set too high, or to avoid reducing the visibility, for example, as a result of headlamps set too low. For motor vehicles registered in the European Union (EU), automatic headlamp range adjustment systems are mandatory for certain types of headlamps.

Sensors for prior solutions to determine pitch angles are complex to integrate in existing vehicles. They are also maintenance-intensive, because they are directly exposed to environmental influences (e.g., the weather and mechanical influences caused by the road, stone chips, etc.). It is, therefore, desirable to replace prior solutions based on mechanical sensors with alternatives. A combination of other available sensors can be particularly useful. While it is possible to determine the load pitch angle using other sensors typically already present in a vehicle, such as acceleration sensors, it is difficult to achieve the required accuracy which allows only small tolerances for light requirements.

Prior methods can determine an averaged pitch angle with respect to the road via images captured by a front camera. The averaged pitch angle is typically determined during driving. Because the pitch angle of the vehicle can vary depending on the driving conditions (e.g., due to driving conditions), the average pitch angle determined via the camera also deviates from the pitch angle of the vehicle that occurs when the vehicle comes to a standstill in a horizontal plane (“load pitch angle”). However, a headlamp range adjustment system requires exactly this load pitch angle as an output variable.

The documents DE 10 2017 005 019 A1, DE 10 2020 128 440 A1, DE 10 2011 017 697 A1, US 2021/0323466 A1 and US 2017/0225609 A1 describe methods and apparatuses for adjusting the headlamp range using a camera. In the document U.S. Pat. No. 10, 953,787 B2, various sensors are used in connection with the headlamp range adjustment. Further prior art is disclosed in the documents EP 2 130 718 A2, CN 112477750 B, DE 10 2021 006290 A1, EP 0 709 240 A1, U.S. Pat. Nos. 6,693,380 B2, 6,450,673 B1, 6,193,398 B1 and 9,260,051 B2.

Against this background, examples of the present disclosure provide advantageous methods for determining the current load pitch angle of a vehicle for automatic headlamp range adjustment. Examples described herein provide advantageous methods for headlamp range adjustment, advantageous apparatus for headlamp range adjustment, vehicles, computer-implemented methods, computer program products, and a computer-readable carrier media having instructions to be executed by processors.

Examples described herein provide methods for determining the current load pitch angle of a vehicle, methods for headlamp range adjustment, apparatus to adjust headlamp range, vehicles, computer-implemented methods, computer program products, and computer-readable media having instructions to be executed by processors.

The example methods described herein relate to a vehicle which includes at least one device to determine (e.g., measuring, calculating, etc.) an averaged pitch angle. The vehicle also includes at least one device to capture (e.g., detect) at least one parameter characterizing a change in the load of the vehicle. The device to determine an averaged pitch angle may be an environment capture apparatus such as, for example, a camera. The environment capture apparatus may be configured to capture data regarding the road ahead of the vehicle. Advantageously, the environment capture apparatus is configured to determine an averaged pitch angle of the vehicle, for example, determine the deviation of the pitch angle from the factory condition or from the unladen condition.

An example method includes at least the following operations. Data for determining an averaged pitch angle of the vehicle is captured. In some examples, data is captured during a defined or specified time interval or time window (e.g., calibration time interval or calibration time window). At least one parameter indicating a change in the load of the vehicle is captured (e.g., detected). In some examples, the at least one parameter is captured during the defined or specified time interval or time window. Based on the captured at least one parameter indicating a change in the load condition of the vehicle, it is determined whether the load of the vehicle has changed, for example, whether the load of the vehicle has changed during the defined or specified time interval or time window. If the load of the vehicle has not changed during a defined or specified time interval or time window, an averaged pitch angle of the vehicle is determined. Data captured during the defined or specified time interval or time window is averaged to determine an averaged pitch angle. The current load pitch angle is then determined based on the averaged pitch angle.

In some examples, if a change in the load condition of the vehicle is captured after the start and before the end of the defined time window, an averaged pitch angle of the vehicle, which was determined using data captured in this time window, is discarded. In other examples, if a change in the load condition of the vehicle is captured after the start and before the end of a defined time window, the defined time window is reset.

The parameter indicating a change in the load condition of the vehicle can include a change in a gravitation angle (e.g., based on a defined reference axis of the vehicle), and/or a change in an operating condition of the vehicle. Operating conditions can include the opening, closing, or otherwise use of windows, doors, tailgates, seatbelts, a passenger area, a trunk of the vehicle, a coupling or decoupling of a trailer, the application of a parking brake, etc. Operating conditions can be captured to determine a change in the load via sensors, such as, for example, cameras, limit switches, etc.

Thus, two procedures or methods are combined with each other within the scope of examples disclosed herein to determine the current load pitch angle. In some examples, the current load pitch angle is determined based on an average pitch angle using a camera system. The camera system can calculate an average pitch angle based on data captured in a specified calibration time window. Changes in the load pitch angle when the vehicle is at a standstill are also tracked. For example, it is possible to observe changes in the gravitation angle during loading or unloading of the vehicle, and/or a change in the load condition of the vehicle can be derived from other captured variables or parameters. Whereas a camera system for determining the load pitch angle requires a movement of the vehicle, a system to observe and track the gravitation angle or to observe and track other parameters indicating a change in the load condition of the vehicle can be used even when the vehicle is at a standstill.

Example methods disclosed herein include the advantage that a load pitch angle can be determined without using the height sensors described at the outset. Thus, in connection with a headlamp range adjustment, the use of height sensors may possibly be omitted. This can reduce complexity, namely the complexity of the height sensor itself and the complexity of its installation and maintenance. In addition, the reliability of the determination of the load pitch angle and, thus, of the headlamp range adjustment is improved, because no moving components are needed to determine the pitch angle. The reliability and accuracy of the determination of the load pitch angle are also improved by considering a change in the load of the vehicle in the determination. This avoids distorted results due to a change in the load of the vehicle.

In some examples, the defined time window is a maximum of 60 seconds (e.g., a maximum of 30 seconds). Deviations therefrom may arise depending on the current driving conditions.

The device to determine, for example, measure and/or calculate, an averaged pitch angle of the vehicle may include at least one camera.

An example method for adjusting the headlamp range of at least one headlamp (e.g., a front headlamp) of a vehicle includes at least the following operations. First, a setting position of the at least one headlamp is determined. The prerequisite for this is an adjustment of the zero angle. Thus, with a nominal basic setting of a stepper motor angle, the headlamp is calibrated as part of installation in such a way that a defined light exit gradient is achieved. Normally, at the end of the production line, the headlamp is set to a “zero position” (e.g., on the control side). Because the headlamps as a component contain large mechanical tolerances, the angle is then corrected via adjusting screws or electronic control such that the light exits at a fixed angle. This process is also referred to as “setting” or “aiming” and provides the setting position as a prerequisite for any further compensation. The subsequent headlamp range adjustment (e.g., levelling) determines changes in the angle between the vehicle and the ground and compensates for the fixed light exit angle or the required deviation from the setting position.

After determining the setting position of the at least one headlamp, the current load pitch angle of the vehicle is determined. In a next operation, the deviation of the current load pitch angle of the vehicle from the setting position and, thus, the resulting deviation of the at least one headlamp from the setting position is determined. A new target angle can be defined. The setting of the light exit angle of the at least one headlamp is then adjusted according to the deviation determined. For example, the defined new target angle can be controlled. The headlamp range can be adjusted by mechanically rotating a swivel frame by the required angle (e.g., in a manner controlled by a stepper motor). With high-resolution pixel headlamps, it is also possible to switch pixel rows on or off to avoid emitting light above the desired light-dark boundary. In other words, a change in the light exit angle is compensated for.

Examples methods disclosed herein include the features and advantages already described in connection with the above-described example methods.

Example apparatus to adjust the headlamp range of at least one headlamp of a vehicle includes at least one device to determine an averaged pitch angle (e.g., an environment capture apparatus, a camera, etc.), and a device to capture/detect at least one parameter characterizing a change in the load of the vehicle. The device to determine an averaged pitch angle may be configured to capture the road ahead of the vehicle and/or to determine an averaged pitch angle of the vehicle.

Example apparatus disclosed herein are configured to receive data from the device (e.g., the environment capture apparatus) to determine an averaged pitch angle and from the device to capture or detect at least one parameter characterizing a change in the load of the vehicle. Examples disclosed herein are also configured to execute the above-described example methods for headlamp range adjustment. The apparatus accordingly includes the features and advantages described in connection with the above-described example methods.

In some examples, the device to capture (e.g., detect) at least one parameter characterizing a change in the load of the vehicle can include at least one gravitation sensor, and/or at least one device (e.g., a camera) to capture the passenger compartment and/or the luggage compartment, and/or at least one sensor to capture the operating condition of at least one seat belt, and/or at least one sensor to capture the operating condition (e.g., the opening and/or closing condition) of the windows and/or doors and/or a tailgate of the vehicle, and/or at least one sensor to capture the operating condition of a parking brake of the vehicle, and/or at least one sensor to capture the operating condition of a trailer coupling of the vehicle. In some examples, capturing the passenger compartment may include use of an ultrasonic sensor in the interior that detects the presence of cargo and/or persons, or an interior microphone or seat mats with load detection capabilities, which are also used for restraint systems and belt monitoring, for example.

Vehicles according to the examples described herein include the above-described apparatus to adjust headlamp range. The vehicles include the advantages described above. The vehicles can be an electric vehicle or a hybrid electric vehicle (HEV). The vehicles may be motor vehicles (e.g., an automobile, a truck, a bus, a minibus, a motorcycle, or a moped).

Computer-implemented methods disclosed herein include instructions which, when executed by a computer, cause the computer to execute a method according to the examples disclosed herein. The computer program product according to example disclosed herein include instructions which, when executed by a computer, cause the computer to execute methods according to the examples described above. Computer program products according to the disclosed examples are stored on computer-readable storage media. Computer-implemented methods according to the examples described herein, the computer program product according to the examples described herein, and the computer-readable storage media according to examples described herein include the features and advantages described above.

Disclosed examples are described in more detail below with reference to the accompanying figures. Examples described herein are not restricted by the disclosed examples, and other variations may be derived therefrom by a person skilled in the art without departing from the scope of protection of the described examples.

The figures are not necessarily true to scale and may be presented on an enlarged scale or a reduced scale to provide a better overview. Therefore, functional details disclosed here are to be understood not as being of a limiting nature but rather as illustrative to provide a person skilled in the art in this technological field with guidance for using the present described examples in a versatile manner.

The expression “and/or” used here, when used in a series of two or more elements, means that each of the stated elements may be used alone, or any combination of two or more of the stated elements may be used. For example, if a composition comprising the components A, B and/or C is described, the composition may comprise A on its own; B on its own; C on its own; A and B in combination; A and C in combination; B and C in combination; or A, B and C in combination.

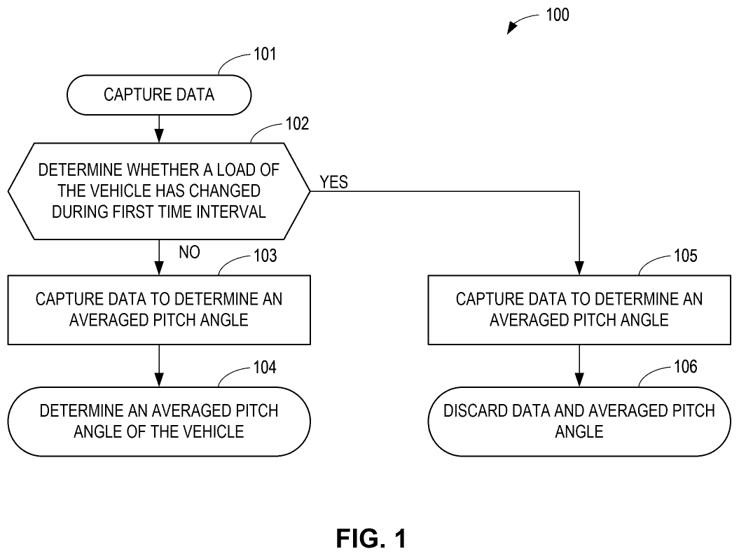

FIG. 1 is a flowchart representative of example machine-readable instructions and/or example operations that may be executed, instantiated, and/or performed by example programmable circuitry to implement an example method 100 for determining a current load pitch angle of a vehicle including an automatic headlamp range adjustment system. In operation 101, the programmable circuitry captures data that may be used to determine an averaged pitch angle of the vehicle (e.g., a plurality of images of the road ahead of the vehicle via an environment capture apparatus), at the beginning of a defined or specified time window or time interval. In operation 102, at least one parameter indicating a change in the load of the vehicle is captured and based on the captured at least one parameter indicating a possible change in the load condition of the vehicle, it is determined whether the load of the vehicle has changed.

If the load condition of the vehicle has not changed, data that may be used to determine an averaged pitch angle of the vehicle is captured in operation 103 until the end of the defined or specified time window or time interval. Then, in operation 104, an averaged pitch angle of the vehicle is determined (e.g., calculated), wherein data captured during the defined time interval is averaged to determine an averaged pitch angle. If it is determined in operation 102 that the load of the vehicle has changed, data for determining an averaged pitch angle of the vehicle is captured in operation 105 until the end of the defined or specified time window or time interval. Then, in operation 106, the data captured in the time window and, if appropriate, an averaged pitch angle of the vehicle determined therefrom are discarded.

In operation 102, a potential change in the load condition of the vehicle can be captured using variables or parameters already described in detail above. For example, an operating condition of the doors, windows, a tailgate, a parking brake, or the seat belts can be captured and evaluated regarding a change in the load of the vehicle. In this context, the interior of the vehicle can also be monitored via a camera or comparable sensors.

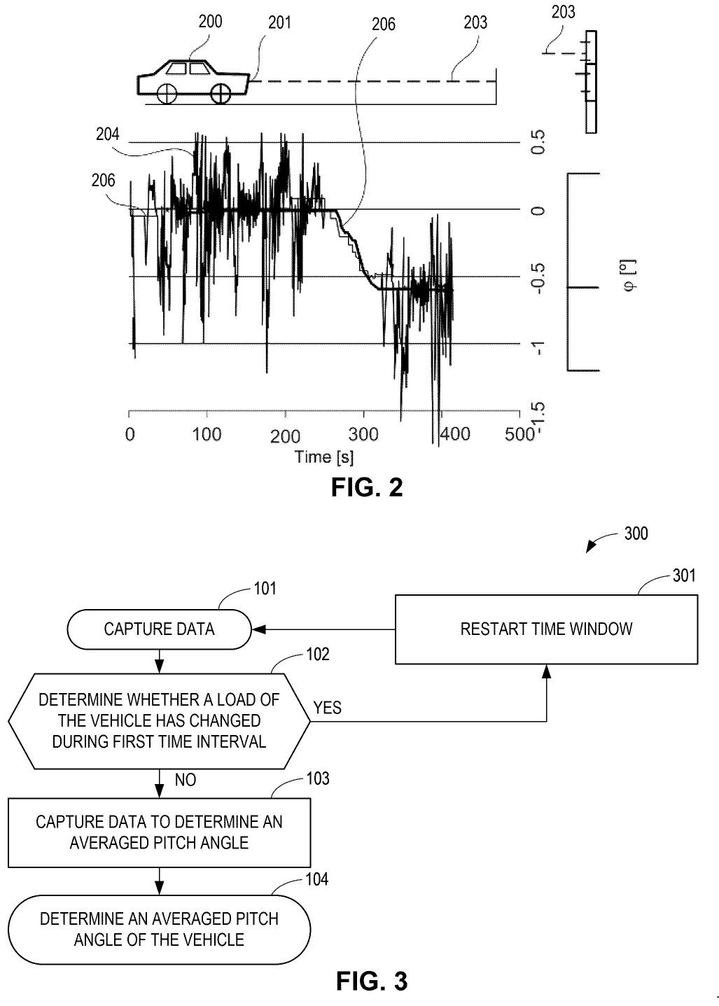

FIG. 2 shows an example diagram including deviations of measured values that occur in a camera-based determination of the pitch angle because of a change in load. The time t in seconds(s) is plotted on the x-axis and the pitch angle φ in degrees (°) is plotted on the y-axis. Shown above the diagram is a vehicle 200 with a headlamp 201 and its emission direction of light 203, which depends on the current pitch angle. The vehicle 200 moves in a first time interval of zero seconds (t=0 s) to approximately two hundred and fifty seconds (t=250 s); at t=250 s, the vehicle 200 comes to a standstill and is loaded until the time three hundred and twenty seconds (t=320 s). The curve 204 indicates a measurement of the pitch angle via a reference sensor. The curve 205 indicates the values from the reference sensor that were each last measured at a standstill. The curve 206 indicates a pitch angle estimated in a camera-based manner. The estimation results from averaged measurements of the pitch angle (e.g., measurement points marked with *) determined by the camera during the journey and an observation of the change in the gravitation angle at a standstill. Depending on whether the selected time window, from which the data are used for the averaging, includes the period of the change in the load condition, this has a significant effect on the determined load pitch angle and can lead to significant deviations and errors compared to the actual current load pitch angle. Therefore, according to the described example, data or results based thereon, which were captured during a change in the load condition of the vehicle, are eliminated. This significantly improves the reliability of the determination of the current load pitch angle.

FIG. 3 is a flowchart representative of machine-readable instructions and/or example operations that may be executed, instantiated, and/or performed by example programmable circuitry to implement the example method 300 for determining a current load pitch angle of a vehicle including an automatic headlamp range adjustment system. In contrast to the example illustrated in FIG. 1, if it is determined in operation 102 that the load of the vehicle 200 has changed (operation 102: Y), a new time window is started in operation 301. In other words, the defined time window is restarted and the capturing of data is restarted. The advantage of this example is the time efficiency, because a measurement that is not used any further is immediately discarded.

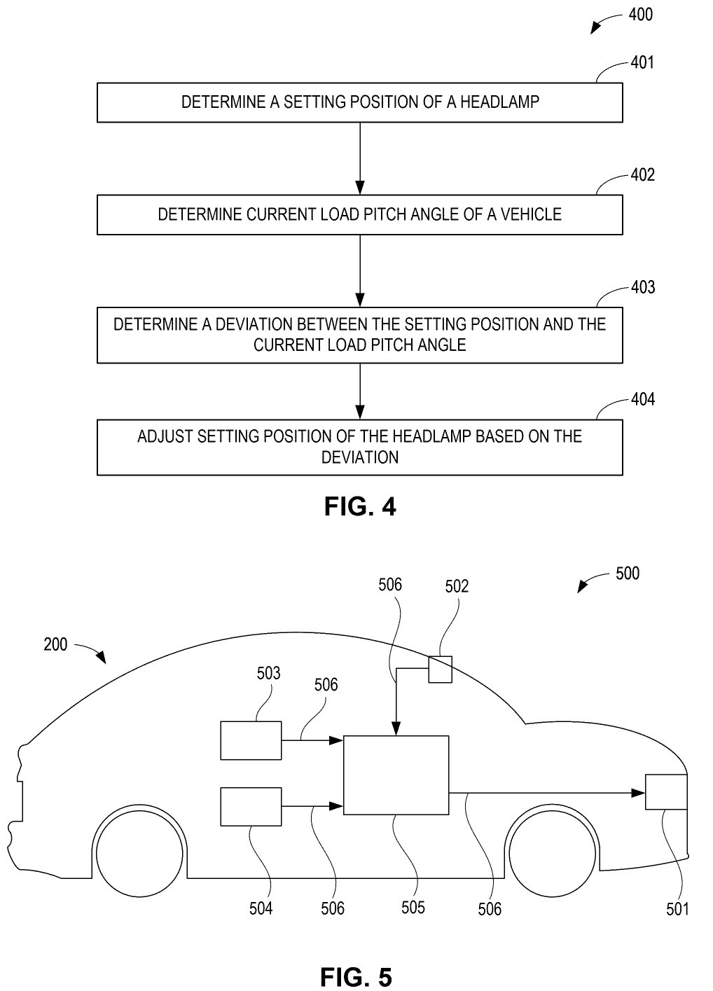

FIG. 4 is a flowchart representative of example machine-readable instructions and/or example operations that may be executed, instantiated, and/or performed by example programmable circuitry to implement example method 400 for automatic headlamp range adjustment. In operation 401, a setting position of the at least one headlamp 201 is determined to control the headlamp range. The prerequisite for this is an adjustment of the zero angle. Thus, with a nominal basic setting of a stepper motor angle, the headlamp 201 is calibrated as part of installation in such a way that a defined light exit gradient is achieved. This means that the headlamp 201 is mechanically and/or optically calibrated (e.g., a headlamp setting). A zero angle can be commanded to the headlamp range setting. At the same time, the corresponding load pitch angle (e.g., a reference load angle, a zero-load angle) can be determined (e.g., in a reference station with known targets).

In operation 402, the current load pitch angle of the vehicle 200 relative to the zero load angle or to the setting position determined in operation 401 is determined, for example, via a method explained based on FIGS. 1 and 3. In operation 403, the deviation of the current load pitch angle from the setting position and, thus, the resulting deviation of the headlamp from the setting position, is determined based on the determined current load pitch angle of the vehicle. In this context, a new target angle can be defined. Then, in operation 404, the setting of the light exit angle of the at least one headlamp 201, is adjusted according to the determined deviation (e.g., the defined new target angle).

Example instructions and/or operations of FIGS. 1, 3, and 4 may be implemented using executable instructions (e.g., computer-readable, and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (e.g., mechanical, magnetic, and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 shows the vehicle 200 including an apparatus 500 to adjust headlamp range in accordance with teachings disclosed herein. The motor vehicle 200 includes at least one headlamp 501 (e.g., a front headlamp), and a device 502 to determine an averaged pitch angle of the vehicle 200 (e.g., an environment capture apparatus, a camera, etc.), which may be mounted on a windshield. Furthermore, the vehicle 200 or the apparatus 500 to adjust headlamp range includes a device 503 to capture at least one parameter characterizing a change in the load of the vehicle 200. In some examples, the vehicle 200 or the apparatus 500 to adjust headlamp range may include at least one gravitation sensor 504.

The apparatus 500 for handlamp range adjustment is configured to receive data from the device 502 to determine an averaged pitch angle of the vehicle 200 and from the device 503 to capture at least one parameter characterizing a change in the load of the vehicle 200, and to carry out an example method for headlamp range adjustment such as, for example, a method described with reference to FIGS. 1 and 3. The data transmission is indicated in FIG. 5 in each case by arrows with the reference number 505. For setting, controlling or adjusting, the headlamp range of the headlamp 501, the apparatus 500 to adjust headlamp range transmits corresponding data to a control unit that, for example, may be used to control a stepper motor within the headlamp 501.

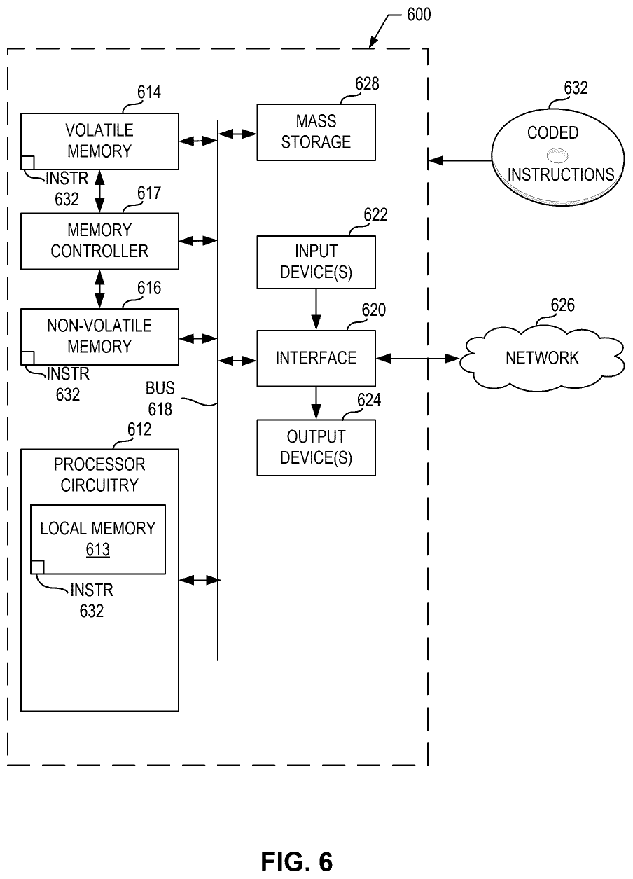

FIG. 6 is a block diagram of an example programmable circuitry platform 600 structured to execute and/or instantiate the example machine-readable instructions and/or the example operations of FIGS. 1, 3, and 4 to implement the headlamp range adjustment apparatus 500 and/or its various components disclosed herein. The programmable circuitry platform 600 can be, for example, a control device, an ECU, a self-learning machine (e.g., a neural network), or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, VPUs, DSPs, and/or microcontrollers from any desired family or manufacturer. The programmable circuitry 612 may be implemented by one or more semiconductor based (e.g., silicon based) devices.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a button, a touchscreen, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 620 of the illustrated example, thus, typically includes a graphics driver card, a graphics driver chip, and/or graphics processor circuitry such as a GPU.

Example methods, apparatus, systems, and articles of manufacture to enable determining a current load pitch angle of a vehicle for automatic headlamp range adjustment are disclosed herein. Further examples and combinations thereof include the following:

Example 1 includes a method to adjust a headlamp of a vehicle including capturing data from a sensor during a first time interval, based on the data, determining whether a load of the vehicle has changed, if the load of the vehicle has not changed during the first time interval, determining an averaged pitch angle of the vehicle, wherein determining the averaged pitch angle includes averaging the data captured during the first time interval, determining a load pitch angle based on the determined pitch angle, and adjusting a position of the headlamp of the vehicle based on the load pitch angle.

Example 2 includes any preceding clause(s) of Example 1, further including discarding the averaged pitch angle after a change in the load of the vehicle is detected after a start and before an end of the first time interval.

Example 3 includes any preceding clause(s) of Examples 1-2, further including restarting the first time interval after a change in the load of the vehicle is detected after a start and before an end of the first time interval.

Example 4 include any preceding clause(s) of Examples 1-3, further including capturing a parameter indicating a change in the load of the vehicle, wherein the parameter indicating the change in the load of the vehicle corresponds to at least one of a gravitation angle, an operating condition of at least one of a window, a door, or a tailgate, an operating condition of a seat belt, an operating condition of a trailer coupling, an operating condition of a parking brake, or an operating condition of at least one of a passenger compartment or a luggage compartment of the vehicle.

Example 5 includes any preceding clause(s) of Examples 1-4, wherein the sensor includes a camera.

Example 6 includes a method to adjust a headlamp of a vehicle, the method includes determining a setting position of the headlamp, determining a current load pitch angle of the vehicle, determining a load of the vehicle, after a load of the vehicle has changed during a first time interval, determining a deviation of the current load pitch angle of the vehicle from the setting position, and adjusting a position of the headlamp based on the deviation.

Example 7 includes any preceding clause(s) of Example 6, further including restarting the first time interval after the change in the load during the first time interval.

Example 8 includes any preceding clause(s) of Examples 6-7, wherein determining the load of the vehicle includes determining a change in a gravitation angle.

Example 9 includes any preceding clause(s) of Examples 6-8, wherein determining the load of the vehicle includes determining a change in an operating condition of at least one of a window, a door, or a tailgate of the vehicle.

Example 10 includes any preceding clause(s) of Examples 6-9, wherein determining the load of the vehicle includes determining a change in an operating condition of a seat belt of the vehicle.

Example 11 includes any preceding clause(s) of Examples 6-10, wherein determining the load of the vehicle includes determining a change in an operating condition of a trailer coupling of the vehicle.

Example 12 includes any preceding clause(s) of Examples 6-11, wherein determining the load of the vehicle includes determining a change in an operating condition of a parking brake of the vehicle.

Example 13 includes any preceding clause(s) of Examples 6-12, wherein determining the load of the vehicle includes determining a change in an operating condition of at least one of a passenger compartment or a luggage compartment of the vehicle.

Example 14 includes an apparatus to adjust a headlamp of a vehicle, the apparatus including a first device to determine an averaged pitch angle of the vehicle, a second device to capture a parameter indicating a change in the load of the vehicle, and a control device including machine-readable instructions to cause the control device to receive first data from the first device, the first date including the averaged pitch angle of the vehicle, receive second data from the second device, the second data including the parameter characterizing the change in the load of the vehicle, determine whether the load of the vehicle has changed during a first time interval based on the second data, and after the load of the vehicle has not changed during the first time interval, determine a load pitch angle based on the first data and the second data.

Example 15 includes any preceding clause(s) of Example 14, wherein the second device includes at least one gravitation sensor.

Example 16 includes any preceding clause(s) of Examples 14-15, wherein the second device includes at least one camera to capture an operating condition of at least one of a passenger compartment or a luggage compartment of the vehicle.

Example 17 includes any preceding clause(s) of Examples 14-16, wherein the second device includes a sensor to capture an operating condition of a seat belt of the vehicle.

Example 18 includes any preceding clause(s) of Examples 14-17, wherein the second device includes a sensor to capture an operating condition of at least one of a window, a door, or a tailgate of the vehicle.

Example 19 includes any preceding clause(s) of Examples 14-18, wherein the second device includes a sensor to capture an operating condition of a parking brake of the vehicle.

Example 20 includes any preceding clause(s) of Examples 14-19, wherein the second device includes a sensor to capture an operating condition of a trailer coupling of the vehicle.

1. A method to adjust a headlamp of a vehicle comprising:
capturing data from a sensor during a first time interval;
based on the data, determining whether a load of the vehicle has changed;
if the load of the vehicle has not changed during the first time interval, determining an averaged pitch angle of the vehicle, wherein determining the averaged pitch angle includes averaging the data captured during the first time interval;
determining a load pitch angle based on the determined averaged pitch angle; and
adjusting a position of the headlamp of the vehicle based on the load pitch angle.

2. The method of claim 1, further including discarding the averaged pitch angle after a change in the load of the vehicle is detected after a start and before an end of the first time interval.

3. The method of claim 1, further including restarting the first time interval after a change in the load of the vehicle is detected after a start and before an end of the first time interval.

4. The method of claim 1, further including capturing a parameter indicating a change in the load of the vehicle, wherein the parameter indicating the change in the load of the vehicle corresponds to at least one of:
a gravitation angle;
an operating condition of at least one of a window, a door, or a tailgate;
an operating condition of a seat belt;
an operating condition of a trailer coupling;
an operating condition of a parking brake; or
an operating condition of at least one of a passenger compartment or a luggage compartment of the vehicle.

5. The method according to claim 1, wherein the sensor includes a camera.

6. A method to adjust a headlamp of a vehicle, the method comprising:
determining a setting position of the headlamp;
determining a current load pitch angle of the vehicle;
determining a load of the vehicle;
after a load of the vehicle has changed during a first time interval, determining a deviation of the current load pitch angle of the vehicle from the setting position; and
adjusting a position of the headlamp based on the deviation.

7. The method of claim 6, further including restarting the first time interval after the change in the load during the first time interval.

8. The method of claim 6, wherein determining the load of the vehicle includes determining a change in a gravitation angle.

9. The method of claim 6, wherein determining the load of the vehicle includes determining a change in an operating condition of at least one of a window, a door, or a tailgate of the vehicle.

10. The method of claim 6, wherein determining the load of the vehicle includes determining a change in an operating condition of a seat belt of the vehicle.

11. The method of claim 6, wherein determining the load of the vehicle includes determining a change in an operating condition of a trailer coupling of the vehicle.

12. The method of claim 6, wherein determining the load of the vehicle includes determining a change in an operating condition of a parking brake of the vehicle.

13. The method of claim 6, wherein determining the load of the vehicle includes determining a change in an operating condition of at least one of a passenger compartment or a luggage compartment of the vehicle.

14. An apparatus to adjust a headlamp range of a headlamp of a vehicle, the apparatus comprising:
a first device to determine an averaged pitch angle of the vehicle;
a second device to capture a parameter indicating a change in a load of the vehicle; and
a control device including machine-readable instructions to cause the control device to:
receive first data from the first device, the first data including the averaged pitch angle of the vehicle;
receive second data from the second device, the second data including the parameter characterizing the change in the load of the vehicle;
determine whether the load of the vehicle has changed during a first time interval based on the second data; and
after the load of the vehicle has not changed during the first time interval, determine a load pitch angle based on the first data and the second data.

15. The apparatus of claim 14, wherein the second device includes at least one gravitation sensor.

16. The apparatus of claim 14, wherein the second device includes at least one camera to capture an operating condition of at least one of a passenger compartment or a luggage compartment of the vehicle.

17. The apparatus of claim 14, wherein the second device includes a sensor to capture an operating condition of a seat belt of the vehicle.

18. The apparatus of claim 14, wherein the second device includes a sensor to capture an operating condition of at least one of a window, a door, or a tailgate of the vehicle.

19. The apparatus of claim 14, wherein the second device includes a sensor to capture an operating condition of a parking brake of the vehicle.

20. The apparatus of claim 14, wherein the second device includes a sensor to capture an operating condition of a trailer coupling of the vehicle.
